(19) United States
(12) Patent Application Publication
(10) Pub. No.: US 2008/0229319 A1
(43) Pub. Date: Sep. 18, 2008

(54) Global Resource Allocation Control

(76) Inventor: Benoit Marchand, Saint-Lambert (CA)

Correspondence Address: CARR & FERRELL LLP, 2200 GENG ROAD, PALO ALTO, CA, 94303, US

(21) Appl. No.: 12/045,258

(22) Filed: Mar. 10, 2008

Related U.S. Application Data
(60) Provisional application No. 60/893,628, filed on Mar. 8, 2007.

(51) Int. Cl. G06F 9/50

(52) U.S. Cl. 718/104

(57) ABSTRACT

Improved workload management is provided by introducing a global resource allocation control mechanism in a service layer, which may be located above or within the host operating system. The mechanism arbitrates how, when, and by which application resources of all types are being consumed.

### CROSS-REFERENCE TO RELATED APPLICATIONS

The present application claims the priority benefit of U.S. provisional patent application No. 60/893,628 filed Mar. 8, 2007 and entitled “Job Dispatch Optimization,” the disclosure of which is incorporated herein by reference.

### BACKGROUND OF THE INVENTION

1. Field of the Invention

The present invention generally relates to workload management. More specifically, the present invention relates to optimizing the processing capacity of multi-processor and multi-core computer systems.

2. Description of the Related Art

Technical and commercial software applications are increasingly operated in multi-processor and multi-core computer systems. While these systems allow for rapid scalability of processing power, other system components may not scale at the same rate. Imbalances result that create bottlenecks and limit application performance and system efficiency.

Operating systems (OS) are inclusive of software mechanisms and modules that manage processing device resources. Linux, Solaris, and Windows are examples of an OS as are JAVA virtual machines and embedded device system management applications. The aforementioned OS will generally attempt to provide fair resource access. In many instances, however, an OS will aggravate resource bottlenecks by indiscriminately granting immediate resource access to all requesting jobs. Prior art OS lack resource allocation mechanisms that may detect and prevent applications from interfering with one another through their use of any particular resource.

Prior art OS further lack the ability to detect and remedy resource allocation conflicts. This inability has only been worsened by recent information technology advancements where resources are no longer confined to the realm of an OS. For example, heterogeneous multi-core processors (i.e., processor cores that are not on an integrated circuit embodying the same processor type), graphic processing units (GPUs), field programmable gate arrays (FPGAs), software caching tools, virtualization tools, parallel application libraries, and Direct Memory Access (DMA) based network interfaces all introduce new resource types over which prior art OS have no effective control.

One solution has been to complement prior art OS with grid and cluster workload management tools. One such tool tracks and limits the number of concurrent applications running on a computer system through processing slot availability where workload management tools grant exclusive access to a fixed number of processors—usually one. Another prior art solution involves memory allocation control, which grants system memory quotas at startup, where an application is ‘terminated’ should that application attempt to utilize more memory than allowed. Terminating ‘greedy’ applications prevents interference with other applications sharing the same processing node (e.g. any computing device or electronic appliance including a personal computer, interactive or cable television terminal, cellular phone, or PDA). Ad hoc solutions such as processing slot availability and memory allocation control must be deployed independently for each resource type to be managed. Deployment of these schemes over large heterogeneous infrastructures and complex application workflows often proves insurmountably cumbersome.

Another solution has been to dispatch workload management tools based on resource monitoring information gathered from participating processing systems. For example, system-wide deployed resource monitors may report 75% CPU utilization and 90% memory usage to a workload management tool. From this information, the workload management tool may allow for the execution of an application that can operate within the 25% CPU and 10% memory availability. Monitoring, however, only provides an instantaneous picture of resource consumption and not a long-term view into application resource requirements. These monitoring schemes introduce sampling delays and resource minima to prevent resource oversubscription, which may lower system efficiency. The introduction of dispatch delays to reduce the likelihood of inappropriately dispatching an application that will wreak havoc with other applications further contributes to lowered system efficiency.

Monitor based workload management tools are also limited with respect to the size of the system in which they can be used. As processor count increases, the per-processor contribution diminishes. In a dual processor system, for example, each processor contributes to 50% of total processing capacity while the per-processor contribution may only be 6.25% in a sixteen processor system. Increasing processor count also impacts monitoring. More processors require higher sampling rates since resource consumption will increasingly vary during a sampling interval.

Information technology requires new tools to manage resource allocation in a more dynamic and efficient way than prior art OS alone or when combined with workload managers. There is a further need to address the problem of allowing higher processing efficiency while preventing application interference. Still further, there is a need to manage all application resource types that may escape OS control.

### SUMMARY OF THE INVENTION

Embodiments of the present invention implement a scalable global resource allocation mechanism. The mechanism allows multi-processor and multi-core computer systems to operate more efficiently. The mechanism simultaneously prevents application interference. Application response time is minimized without requiring any particular modifications to existing software components or with respect to management of any particular application resource type.

In an embodiment of the presently claimed invention, a method for allocation of resources in a computing environment is provided. Through the claimed method, an application submission is intercepted and arbitrated. Arbitration of the intercepted application prevents interference with another application submission and manages consumption of application resources.

### BRIEF DESCRIPTION OF THE DRAWINGS

FIG. 1 illustrates an exemplary global resource allocation module and its constituent components.

FIG. 2 illustrates an exemplary system for dispatching applications and preventing concurrently executed applications from interfering with one another.

FIG. 3 illustrates an exemplary embodiment of a job group where multiple applications may be spooled while resource requirements are satisfied.

FIG. 4 illustrates interaction of an exemplary resource allocation module configured to prevent resource oversubscription.

FIG. 5 illustrates an exemplary scripting user interface.

FIG. 6 illustrates an exemplary command line user interface.

FIG. 7 illustrates an exemplary resource-type matrix.

### DETAILED DESCRIPTION

Embodiments of the present invention improve the speed, scalability, robustness, and dynamism of resource allocation control beyond that made available by operating systems and/or grid/cluster workload management tools in the prior art. A global resource allocation module or mechanism that arbitrates which application is granted access to which resource may be layered on top of existing operating systems. Such a mechanism may, alternatively, be a built-in component of an OS. Resource allocation methodologies may be applied to a single application, a group of applications, or all applications running concurrently on a node.

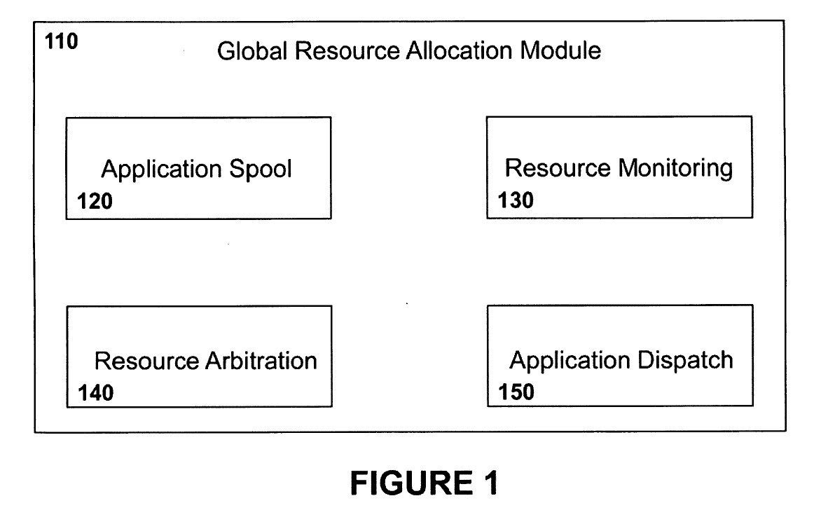

FIG. 1 illustrates an exemplary global resource allocation module (mechanism) 110 and its constituent component modules 120-150. These component modules 120-150 may individually or jointly operate as to maximize resource utilization and/or prevent resource under-utilization, over-subscription, and concurrently running application interference. The four components illustrated in the context of the global resource allocation module 110 of FIG. 1 include application spooling 120, resource monitoring 130, resource arbitration 140, and application dispatching 150.

The application spooling module 120 ‘holds’ applications that have been put in a hold or suspend mode until their specific resource requirements can be satisfied. The resource monitoring module 130 maintains information on resources state such as availability and performance. The resource arbitration module 140 determines which application can use what resources at any given moment based on, for example, resource availability, application resource requirements, user credentials, and prioritization policies.

The application dispatching module 150 commences execution of applications when their resource requirements can be met. Application dispatching module 150 further suspends execution of applications when their resource requirements can no longer be met. For example, when an application resource usage interferes with execution of another application, execution of the corresponding application may be suspended. Similar suspensions may take place in those situations when a high priority application requires that resources held by a lower priority application immediately be released.

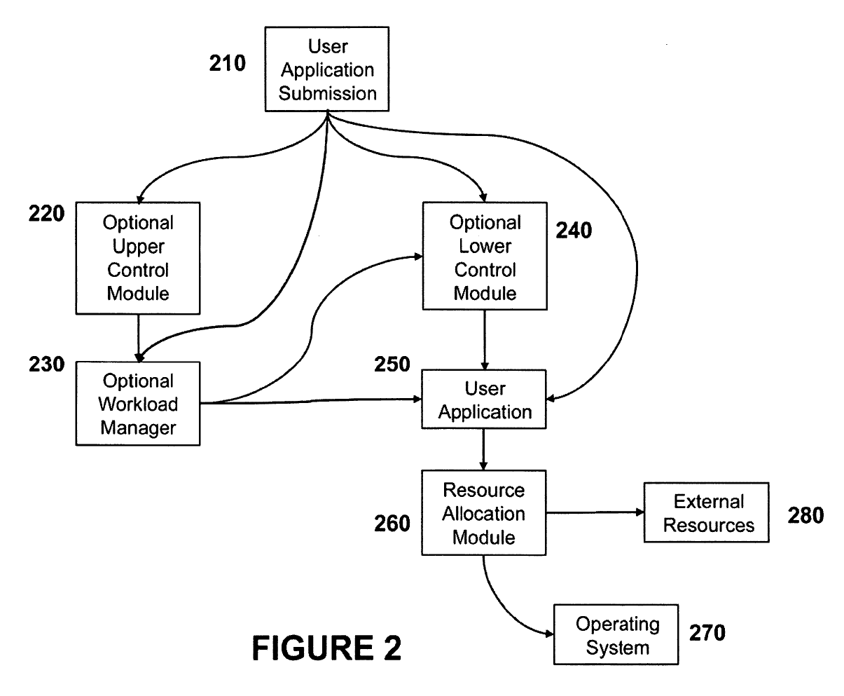

FIG. 2 illustrates an exemplary system 200 for dispatching applications and preventing concurrently executed applications from interfering with one another. System 200, as illustrated in FIG. 2, corresponds to a workload management utility operating jointly with a node operating system. System 200 processes applications and includes a global resource allocation mechanism 260 like that illustrated and described in the context of FIG. 1, and which may be built on top of an OS.

The user application submission module 210 provides a user interface to the system (i.e., execution of this and the other modules described herein provides for certain results or functionality). Through the interface proffered by the user application submission module 210, applications may be executed directly on an OS. Applications may alternatively be submitted to a workload manager utility.

The upper control module 220 may be configured to intercept user job queuing requests to workload managers. Upper control module 220 may be further configured to modify or supplement job queuing requests in order for the dispatched jobs to be integrated with the global resource allocation mechanism 260 (as referenced in FIG. 1). The upper control module 220 may be superfluous with respect to performing integration with a workload manager depending on the particular features supported by the workload manager utility. The aforementioned workload manager utility 230 is, in one embodiment, an externally supplied mechanism used to queue and dispatch user job requests. The workload manager utility 230 may thus be integrated with system 200.

The lower control module 240 may be configured to intercept applications being dispatched on a computer system. Through such interception, applications may perform their resource allocation requests through the global resource allocation mechanism 260. Applications may be scheduled to run, suspend, or resume execution by said global resource allocation mechanism 260. The lower control module 240 may, in some embodiments, be omitted from implementing the resource allocation mechanism. For example, the module 240 may be omitted where the OS and user interface mechanisms (i.e. its ‘shell’) support features that allow applications to integrate with the global resource allocation mechanism 260 transparently (i.e., without explicitly intercepting application dispatches).

In system 200, users may submit applications 210 to the aforementioned upper control module 220. Upper control module 220 may intercept job submission in order to force applications, once dispatched, to make use of the global resource allocation mechanism 260. The upper control module 120 then forwards the user application submission to the workload manager module 230 where normal job queuing/dispatch activities occur.

When applications are dispatched to computer systems, the lower control module 240 may intercept user application 250 before the application is executed or ‘started.’ The lower control module 240 may set the user application run-time environment such that all resource allocation/de-allocation requests are intercepted by the global resource allocation mechanism 260. The global resource allocation mechanism 260 arbitrates resource allocation to prevent applications from interfering with one another through their resource usage. Once cleared of conflicts, applications are allowed to proceed through to the operating system 270 or potentially to external resource modules 280.

External resource module 280 may include any system external to the OS. For example, external resource module 280 may provide services and resources to running applications such as data caching, license management, or a database. The concurrent use of external resource modules by multiple applications may create interference within the applications (i.e., bottlenecks).

Users, in an alternative embodiment, may execute applications 210 directly through the optional lower control module 240. In a still further embodiment, users may submit applications 210 directly to the global resource allocation mechanism 260. In yet another embodiment, users may submit applications 210 directly to the workload manager module 230.

Global resource allocation mechanism 260 includes a resource monitoring component mechanism that may periodically poll (i.e., sample) the operating system 270 or the external resource modules 280 to obtain resource use and/or status information such as memory and processor availability. Resource polling, in some embodiments, may be replaced and/or complemented with an event-driven mechanism such as ‘callbacks’ that trigger functions once pre-set resource states have been reached. For example, when system memory availability reaches 1 GB (i.e., an event), the resource allocation mechanism triggers the release of an application waiting to allocate memory.

Global resource allocation mechanism 260 may maintain state information of all resources in order to decide whether applications can be allowed to proceed with resource requests such that when applications make resource allocation requests, the resource allocation mechanism has immediate knowledge of resource availability. The resource allocation mechanism 260 may poll state information for all resource sources on-demand such that when applications make resource allocation requests, the resource allocation mechanism checks resource availability at that time. Resource allocation module 260 may be distributed among the resource sources such that when applications make resource allocation requests, accessing resources triggers the resource allocation mechanism. Furthermore, the resource monitoring component mechanism of may be implemented using a combination of the above implementations.

Resource arbitration may be implemented using an application history mechanism. In the application history mechanism, application resource consumption expectations are provided by users when submitting applications. Alternatively, resource consumption history may be retrieved from a historical database that tracks resource consumption from prior executions of the application.

Resource arbitration may alternatively be implemented using a sampling apparatus that periodically obtains user application resource consumption information from the OS 270 or external resources 280. Resource allocation module 260 may also be implemented using a software module library substitution mechanism that traps and maintains resource allocation/de-allocation related information. For example, a memory allocation request may be intercepted in the system memory allocation software module and first be run through the resource allocation module prior to being allowed to proceed with normal memory allocation operation.

Resource arbitration may be a distributed system embedded within the application submission module 210. Resource arbitration may also be part of a client-server process. In such an embodiment, resource requests are processed as client requests within the application interface to the system 200. Furthermore, the resource arbitration component may be implemented using a combination of the above implementations.

The resource allocation module 260 dispatching component mechanism may alternatively be a distributed system embedded within the application submission module 210 or the optional lower control module 240. Resource allocation module 260 dispatching component mechanism may utilize a client-server process. Application dispatch requests may be processed as client requests within the application interface to the system 200.

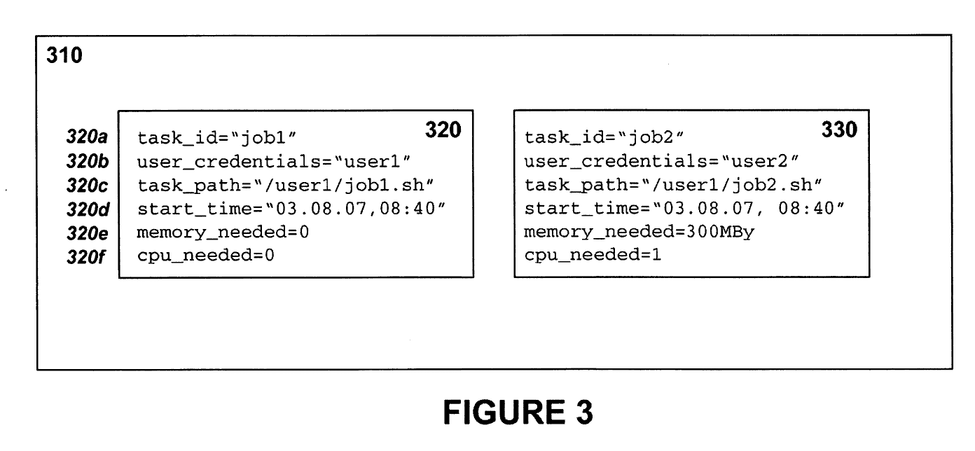

FIG. 3 illustrates an exemplary embodiment 300 of a job group where multiple applications may be spooled while resource requirements are satisfied. A job pool (or group) 310 maintains a set of applications having been dispatched to a computer system. Each application may be represented by a data structure like structure 320 or structure 330 where application credentials and resource requirements are tracked.

Credentials may include application identification 320a, user identification 320b, executable path 320c, and start time 320d such that the resource allocation mechanism may prioritize resource allocation based on user, application name, start time and so forth. Exemplary resource requirements may include memory requirement 320e and processor requirement 320f such that the resource allocation mechanism may prioritize resource allocation based on resource requirements. Resource requirements such as 320e and 320f, when provided ahead of executing an application, may help in improving the performance and efficiency of the resource allocation mechanism.

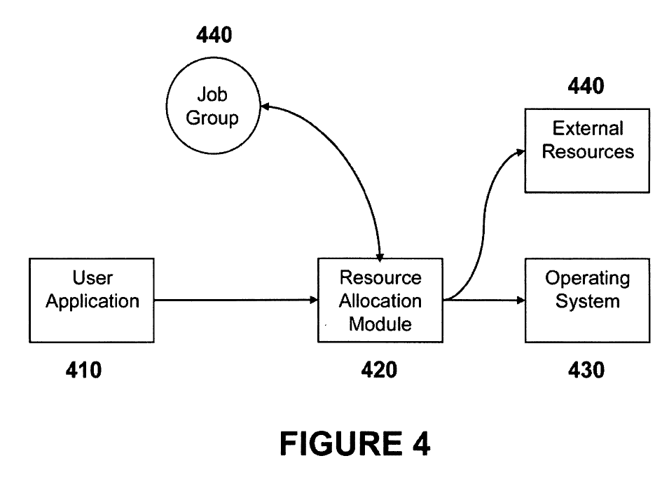

FIG. 4 illustrates interaction of an exemplary resource allocation module 400 configured to prevent resource oversubscription. A user application 410 makes a resource request to the resource allocation module 420. If the resource request can be met without causing interference with other running applications (i.e. conflicting resource requirements) the request is granted to proceed to the operating system 430 420a or external resources 440. If the resource request can not be met then the application can be terminated and re-enter the job group/application pool 440 until it can be re-started or released without causing resource conflicts.

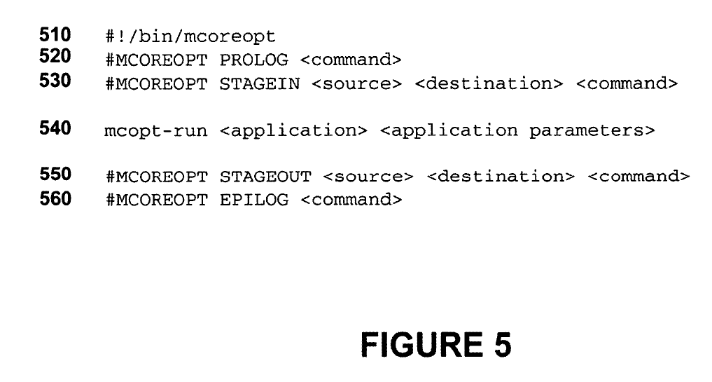

FIG. 5 illustrates an exemplary scripting user interface. Such a scripting user interface may be used for interfacing with a workload manager system such that the workload manager system is unaware that it is using a purpose built scripting device 510 rather than a typical command interpreter scripting system. The scripting user interface may connect user applications with the resource allocation mechanism. User applications may be integrated automatically, such that users need not to explicitly connect user applications with the resource allocation mechanism, through a system-wide configuration mechanism, such as a configuration file. User applications may be integrated to the resource allocation mechanism by setting a resource prior to application submission such as setting a UNIX environment variable.

A scripting user interface may implement mechanisms to allow bulk data transfer/staging independently of application execution. For example staging input data 530, or output data 550 such that bulk data transfers occur prior to/after application execution and, in an exemplary embodiment, may be scheduled to occur at a different time, and potentially through a different scheduling mechanism, than the application. Scripting user interface may implement mechanisms to allow user defined operations to be performed prior to 520 or after application execution 560 such that operations can be executed outside the scope of executing the application and scheduled independently (potentially at a different time, through a different scheduling mechanism, than the application). Scripting user interface is used to launch application execution 540.

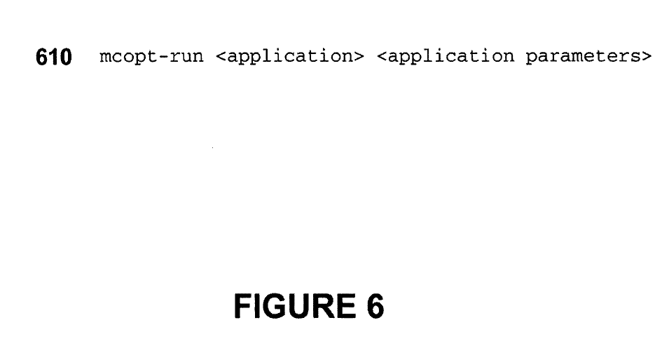

FIG. 6 illustrates an exemplary command line user interface 600. A purpose built command 610 invokes application execution directly and integrates the application resource requests with embodiments of the present invention. A system-wide mechanism may automatically integrate applications to the apparatus. User applications may be integrated into the resource allocation mechanism by setting a resource prior to application submission such as setting a UNIX environment variable.

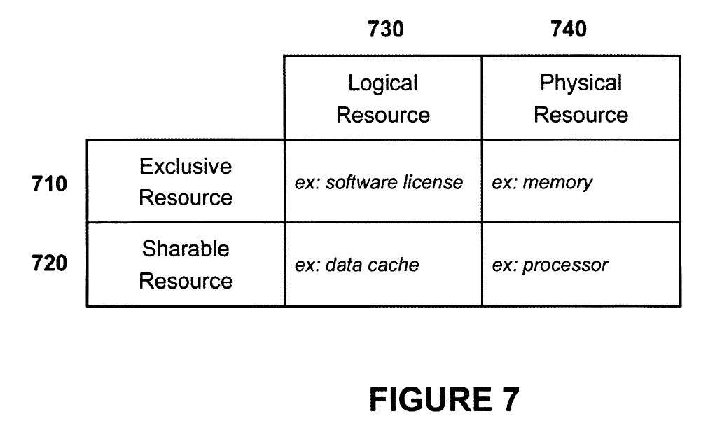

FIG. 7 illustrates an exemplary resource type matrix 700. An embodiment of the present invention may extend the nature of resources that may be controlled through an extensible resource definition. Resources may be defined as exclusive 710, sharable 720, logical 730 or physical 740.

Exclusive 710 resources refer to resources that can be used by a single application at a time such as memory. Sharable 720 resources refer to resources that can be used by more than one application at a time such as a processor. Moreover, the degree of concurrency for a sharable resource may be specified. For instance, a sharable resource may be limited to support up to five concurrent applications. Logical 730 resources refer to resources that do not correspond to computer hardware components such as software licenses while physical 740 resources refer to resources that correspond to computer hardware components such as a hardware accelerator device. For each resource class, a single mechanism may implement all resource control/allocation operations. Further, for each defined resource and resource class, specific characteristics may be defined such as allowed concurrency, allocation/de-allocation rules, timetables, and required user credentials.

While embodiments of the present invention may be applied to resource allocation control used in conjunction with a workload management utility and an operating system, one skilled in the art will recognize that the present invention can be applied to any resource allocation problem type regardless of the underlying mechanisms. It is to be understood that the present invention may be embodied in various forms. Therefore, specific details disclosed herein are not to be interpreted as limiting, but rather as a basis for claims and as a representative basis for teaching one skilled in the art to employ the present invention in virtually any appropriately detailed system, structure, method, process, or manner.

The various methodologies disclosed herein may be embodied in a computer program such as a program module. The program may be stored on a computer-readable storage medium such as an optical disc, hard drive, magnetic tape, flash memory, or as microcode in a microcontroller. The program embodied on the storage medium may be executable by a processor to perform a particular method.

What is claimed is:

1. A method for allocation of resources in a computing environment, the method comprising:
intercepting an application submission; and
arbitrating the intercepted application, wherein arbitrating the intercepted application prevents interference with another application submission and manages consumption of application resources.

2. A computer-readable storage medium having embodied thereon a program, the program being executable by a processor to perform a method for allocation of resources in a computing environment, the method comprising:
intercepting an application submission; and
arbitrating the intercepted application, wherein arbitrating the intercepted application prevents interference with another application submission and manages consumption of application resources.
